(19) United States
(12) Patent Application Publication
(10) Pub. No.: US 2017/0141408 A1
(43) Pub. Date: May 18, 2017

(54) SEPARATOR FOR FUEL CELL AND METHOD FOR MANUFACTURING THE SAME

(71) Applicants: HYUNDAI MOTOR COMPANY, Seoul (KR); UNIVERSITAT ZU KOLN, Cologne (KR)

(72) Inventors: Kwang Hoon CHOI, Yongin-si (KR); Woong Pyo HONG, Seoul (KR); Jiyoun SEO, Suwon-si (KR); Bokyung KIM, Yongin-si (KR); Jungyeon PARK, Yongin-si (KR); In Woong LYO, Suwon-si (KR); Sanjay MATHUR, Cologne (DE); Yakup GÖNÜLLÜ, Cologne (DE); Andreas METTENBÖRGER, Cologne (DE); Thomas FISCHER, Cologne (DE)

(21) Appl. No.: 14/956,181

(22) Filed: Dec. 1, 2015

(30) Foreign Application Priority Data
Nov. 16, 2015 (KR) 10-2015-0160338

(51) Int. Cl. H01M 8/0228; H01M 8/0215; H01M 8/0206

(52) U.S. Cl. CPC H01M 8/0228; H01M 8/0206; H01M 8/0215

(57) ABSTRACT

A separator for a fuel cell includes a base layer, a first metal carbide coating layer disposed at one or both sides of on the base layer; a metal coating layer disposed above the first metal carbide coating layer; and a second metal carbide coating layer disposed above the metal layer.

### TECHNICAL FIELD

The present disclosure relates to a separator for a fuel cell, and a method for manufacturing the same.

### BACKGROUND

In general, a fuel cell stack for a vehicle fuel cell system includes repeatedly stacked parts, such as an electrode membrane, a separator, a gas diffusion layer, and a gasket, and non-repeated parts, such as an engaging system required for the engagement of a stack module, an enclosure for protecting a stack, a part required for providing an interface with a vehicle, and a high voltage connector. In such a fuel cell stack, hydrogen reacts with oxygen in air to generate electricity, water, and heat, in which, high-voltage electricity, water, and hydrogen coexist at the same place, and thus, there are a large number of dangerous factors.

Particularly, in a case of a fuel cell separator, since positive hydrogen ions generated during the operation of a fuel cell directly contact therewith, an anti-corrosive property is required. When using a metal separator without surface treatment, metal corrosion occurs and an oxide produced on the metal surface functions as an electrical insulator leading to degradation of electro-conductivity. In addition, the positive metal ions dissociated and released at that time contaminate a membrane electrode assembly (MEA), resulting in degradation of the performance of the fuel cell.

When a carbon-based separator is used as the fuel cell separator, cracks are generated and may remain in an inner part of the fuel cell. Thus, there is a difficulty in forming a thin film in view of its strength and gas permeability and in terms of processability or the like.

When a metal separator is used, although it shows favorable moldability and productivity due to its excellent ductility and allows thin film formation and downsizing of a stack, it may cause contamination of the MEA due to corrosion and an increase in contact resistance due to the formation of an oxide film on the surface thereof, resulting in deterioration of the performance of a stack. Therefore, there is a need for a surface treatment method that is capable of inhibiting such surface corrosion and oxide film growth.

The above information disclosed in this Background section is only for enhancement of understanding of the background of the invention, and therefore, it may contain information that does not form the prior art that is already known in this country to a person of ordinary skill in the art.

### SUMMARY

An aspect of the present inventive concept provides a separator for a fuel cell.

Another aspect of the present inventive concept provides a method for manufacturing a separator for a fuel cell.

A separator for a fuel cell according to an exemplary embodiment in the present disclosure includes a base layer, a first metal carbide coating layer disposed at one or both sides of the base layer; a metal coating layer disposed above the first metal carbide coating layer; and a second metal carbide coating layer disposed above the metal layer.

The first metal carbide coating layer and the second metal carbide coating layer may respectively include a material selected from titanium carbide, chrome carbide, molybdenum carbide, tungsten carbide, niobium carbide, vanadium carbide, or a combination thereof.

The first metal carbide coating layer and the second metal carbide coating layer may both be titanium carbide.

The separator may further include a graphene or graphite coating layer disposed between the metal coating layer and the second metal carbide coating layer.

The thickness of the graphene or graphite coating layer may be less than 10 nm.

According to another exemplary embodiment in the present disclosure, a method for manufacturing a separator for a fuel cell includes forming a first metal carbide coating layer above a base material; forming a metal coating layer above the first metal carbide coating layer; and forming a second metal carbide coating layer above the metal layer.

The step of forming the first metal carbide coating layer may include: producing a first precursor gas by evaporating a first precursor; introducing a first metal carbide coating layer forming gas containing the precursor gas, a reactive gas, and a carbonaceous gas into a reactive chamber; and forming a metal nitride coating layer on a base material by changing the first metal carbide coating layer into a plasma state by applying a voltage to the reactive chamber.

The step of forming the second metal carbide coating layer may include: manufacturing a second precursor gas by evaporating a second precursor; introducing a second metal carbide coating layer forming gas containing the precursor gas, a reactive gas, and a carbonaceous into a reactive chamber; and forming a metal nitride coating layer on the base material by changing the second metal carbide coating layer forming gas into a plasma state and applying a voltage to the reactive chamber.

The first precursor and the second precursor may respectively be materials selected from a compound represented by Chemical Formula 1, a compound represented by Chemical Formula 2, and a combination thereof:

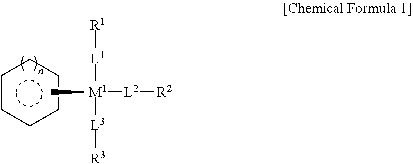

in Chemical Formula 1, M¹ denotes a material selected from Ti, Cr, Mo, W, or Nb, R¹ to R³ independently denote a substituted or unsubstituted C1 to C10 alkyl group, L¹ to L³ are independently —O— or —S—, and n denotes 0 or 1.

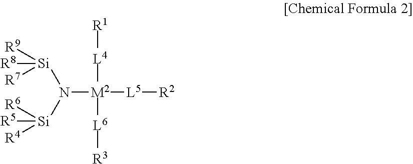

in Chemical Formula 2, M² denotes Ti, Cr, Mo, W, or Nb, R¹ to R³ independently denote a substituted or unsubstituted C1 to C10 alkyl group, R⁴ to R⁹ are independently selected from hydrogen, heavy hydrogen, or a substituted or unsubstituted C1 to C10 alkyl group, and L⁴ to L⁶ are independently —O— or —S—.

The first metal carbide coating layer forming gas and the second metal carbide coating layer forming gas may further include an inert gas and a hydrogen gas.

The first metal carbide coating layer and the second metal carbide coating layer may be formed at a temperature range of lower than or equal to 200° C.

The step of forming the metal coating layer may be performed by a sputtering method.

The method may further include, after the step of forming the metal coating layer, forming a graphene or graphite coating layer.

According to the exemplary embodiments in the present disclosure, the coating layer may be formed at a low temperature, thereby minimizing deformation of the base material.

According to the exemplary embodiments in the present disclosure, the coating layer may be formed at a low temperature, thereby reducing production cost.

According to the exemplary embodiments in the present disclosure, the coating layer can be performed through a PECVD process so that mass large-scaled coating layers can be formed.

According to the exemplary embodiments in the present disclosure, conductivity can be improved by forming the metal coating layer.

According to the exemplary embodiments in the present disclosure, a graphene or graphite coating layer is formed to prevent elution of the metal coating layer, thereby improving coating integrity and durability.

According to the exemplary embodiments of the present inventive concept, a graphene or graphite coating layer is formed to improve a mechanical strength and conductivity.

### BRIEF DESCRIPTION OF THE DRAWINGS

FIG. 1 shows a structure of a separator for a fuel cell according to an exemplary embodiment in the present disclosure.

FIG. 2 shows a structure of a separator for a fuel cell according to another exemplary embodiment in the present disclosure.

FIG. 3 is an SEM photo illustrating a cross-section of a coating layer formed by a first exemplary embodiment.

FIG. 4 is an SEM photo illustrating a cross-section of a coating layer formed by a third exemplary embodiment.

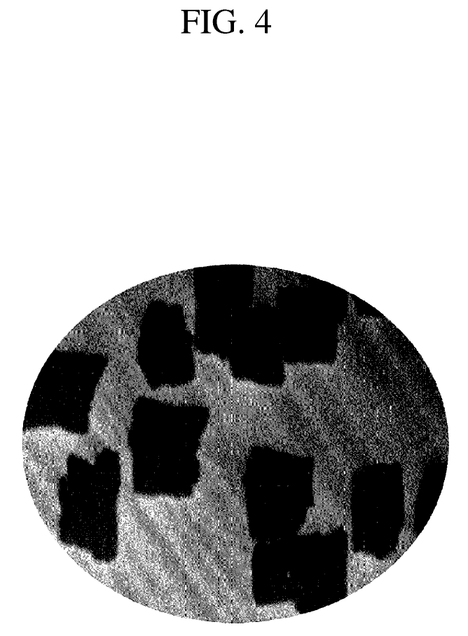

FIG. 5 is a graph comparing adhering forces respectively measured from first to fourth exemplary embodiments.

### DETAILED DESCRIPTION OF THE EMBODIMENTS

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present disclosure will be defined within the scope of claims. Throughout the specification, like reference numerals denote like elements.

Accordingly, technologies well known in some exemplary embodiments are not described in detail to avoid an obscure interpretation in the present disclosure. Unless defined otherwise, it is to be understood that all the terms (including technical and scientific terms) used in the specification has the same meaning as those that are understood by those who skilled in the art. Throughout the specification, unless explicitly described to the contrary, the word “comprise” and variations such as “comprises” or “comprising” will be understood to imply the inclusion of stated elements but not the exclusion of any other element. Further, unless explicitly described to the contrary, a singular form includes a plural form in the specification.

In the specification, the term “substituted,” unless separately defined, means a substitution with a substituent substituted with a C1 to C30 alkyl group; a C1 to C10 alkylsilyl group; a C3 to C30 cycloalkyl group; a C6 to C30 aryl group; a C2 to C30 heteroaryl group; a C1 to C10 alkoxy group; a fluoro group; a C1 to C10 trifluoroalkyl group such as trifluoromethyl group; or a cyano group.

As used herein, unless otherwise defined, “combination thereof” means two or more substituents bound to each other via a linking group, or two or more substituents bound to each other by condensation.

As used herein, unless otherwise defined, “alky group” includes “saturated alkyl group” having no alkene or alkyne group; or “unsaturated alkyl group” having at least one alkene or alkyne group. The “alkene group” means a substituent having at least two carbon atoms bound to each other via at least one carbon-carbon double bond, and “alkyne group” means a substituent having at least two carbon atoms bound to each other via at least one carbon-carbon triple bond. The alkyl group may be branched, linear, or cyclic.

The alkyl group may be a C1 to C20 alkyl group, more particularly a 01 to C6 lower alkyl group, a C7 to 010 medium alkyl group, or a C11 to C20 higher alkyl group.

For example, a C1 to C4 alkyl group means an alkyl group having 1 to 4 carbon atoms in its alkyl chain, and is selected from the group consisting of methyl, ethyl, propyl, isopropyl, n-butyl, isobutyl, sec-butyl, and tert-butyl.

Typical alkyl groups include methyl, ethyl, propyl, isopropyl, butyl, isobutyl, tert-butyl, pentyl, hexyl, ethenyl, propenyl, butenyl, cyclopropyl, cyclobutyl, cyclopentyl, cyclohexyl, or the like.

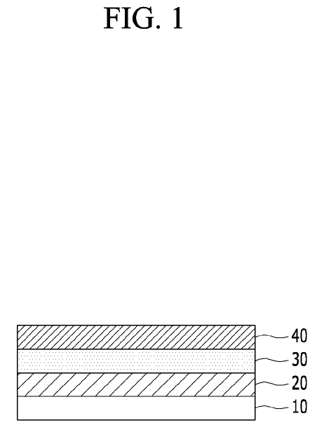

FIG. 1 shows a structure of a separator for a fuel cell according to an exemplary embodiment in the present disclosure.

Referring to FIG. 1, a separator for a fuel cell according to an exemplary embodiment of the present inventive concept includes a first metal carbide coating layer 20 provided in one or lateral sides of a base layer 10, a metal coating layer 30 provided above first metal carbide coating layer 20, and a second metal carbide coating layer 40.

The base layer 10 may be made of stainless steel, titanium, nickel, or aluminum.

In addition, the first metal carbide coating layer 20 and the second metal carbide coating layer 40 may include a material selected from titanium carbide, chrome carbide, molybdenum carbide, tungsten carbide, niobium carbide, vanadium carbide, or a combination thereof.

The first metal carbide coating layer 20 and the second metal carbide coating layer 40 may be titanium carbide (TiC).

The first metal carbide coating layer 20 and the second metal carbide coating layer 40 contribute to improvement of conductivity and corrosion resistance of the separator for a fuel cell.

The thickness of the first metal carbide coating layer 20 may be about 100 nm to about 1000 nm. When the thickness of the first metal carbide coating layer 20 is less than about 100 nm, adhering force of the coating layer may be deteriorated or interface separation may occur. Although there is no limit in thickness of the first metal carbide coating layer 20, but conductivity of the first metal carbide coating layer 20 may be deteriorated if the thickness exceeds 1000 nm.

Further, the thickness of the second metal carbide coating layer 40 may be about 70 nm to about 200 nm. When the thickness of the second metal carbide coating layer 40 is less than about 70 nm, corrosion of the coating layer may be affected due to a gap existing therein. When the thickness of the second metal carbide coating layer 40 exceeds 200 nm, conductivity of the coating layer may be deteriorated.

In addition, a carbonaceous gas may be added when forming the metal carbide layer such that carbon in the first or second metal carbide layer 20 or 30 may be greater than or equal to 30 atomoc % with reference to atomic % of the entire coating layer. Further, TiC combination in the entire coating layers may be greater than or equal to 15%. When the TiC combination is greater than or equal to 15%, it implies that a coating layer compound has 15% of TiC based on the total % of the coating layer compound.

The metal coating layer 30 may include a material selected from Cu, Ni, W, Co, Fe, Ru, Ir, Pd, Pt, or a combination thereof.

The metal coating layer 30 may prevents excessive growth of the first metal carbide coating layer and contributes to improvement conductivity.

The thickness of the metal coating layer 30 may be between 100 nm to 1000 nm. When the thickness of the metal coating layer is less than 100 nm, graphene may not be easily formed. There is no specific limit in thickness of the metal coating layer, but when the thickness exceeds 1000 nm, production cost is increased.

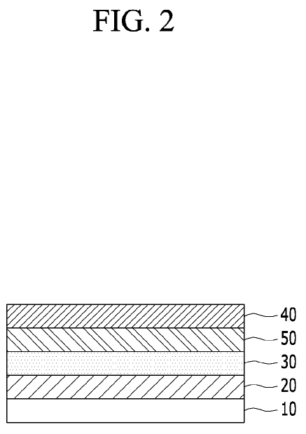

FIG. 2 shows a structure of a separator for fuel cell according to another exemplary embodiment in the present disclosure.

Referring to FIG. 2, a separator for fuel cell according to another embodiment further include a graphene or graphite coating layer 50 disposed between the above-stated metal coating layer 30 and the above-stated second metal carbide coating layer 40.

The graphene or graphite coating layer 50 improves adhering force between the second metal carbide 40 and the metal coating layer 30, thereby improving mechanical strength.

Further, the thickness of the graphene or graphite coating layer 50 may be less than or equal to 10 nm. When the thickness of the graphene or graphite coating layer 50 exceeds 10 nm, flexibility and conductivity of the coating layer may be deteriorated.

Further, there is no specific minimum limit in thickness of the graphene or graphite coating layer 50, but the thickness may be greater than or equal to 2 nm. When the thickness of the graphene or graphite coating layer 50 is less than 2 nm, a conductive characteristic of graphene may not be exhibited.

Hereinafter, a method for manufacturing a separator for fuel cell according to an exemplary embodiment in the present disclosure will be described.

A method for manufacturing a separator for fuel cell according to an exemplary embodiment in the present exemplary disclosure may include forming the first metal carbide coating layer 20 on an upper portion of a base material, forming the metal coating layer 30 on an upper portion of the first metal carbide coating layer 20, and forming the second metal carbide coating layer 40 on an upper portion of the metal coating layer 30.

The step of forming the first metal carbide coating layer 20 and the second metal carbide coating layer 40 may be performed through a plasma enhanced chemical vapor deposition (PE CVD) method.

More specifically, the step of forming the first metal carbide coating layer 20 may include manufacturing a precursor gas by evaporating a first precursor, introducing a first metal carbide coating layer forming gas that includes the precursor gas, a reactive gas, and a carbonaceous gas into a reactive chamber, and forming a metal nitride coating layer on the base material by changing the first metal carbide coating layer forming gas into a plasma state by applying a voltage to the reactive chamber.

The step forming of the second metal carbide coating layer 40 may include manufacturing a second precursor gas by evaporating a second precursor, introducing a second metal carbide coating layer forming gas that includes the precursor gas, a reactive gas, and a carbonaceous gas into the reactive chamber, and forming a metal nitride coating layer on the base material by changing the second metal carbide coating layer forming gas into a plasma state by applying a voltage to the reactive chamber.

The first precursor and the second precursor may be a material selected independently from a compound represented by Chemical Formula 1, a compound represented by Chemical Formula 2, and a combination thereof.

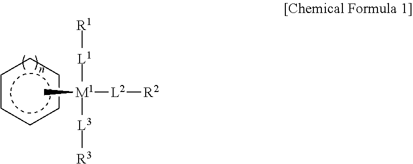

In Chemical Formula 1, M¹ denotes a material selected from Ti, Cr, Mo, W, or Nb, R¹ to R³ independently denote a substituted or unsubstituted C1 to C10 alkyl group, L¹ to L³ independently denote —O— or —S— and, n denotes 0 or 1. The C1 to C10 alkyl group may exemplarily include a material selected from a group consisting of methyl, ethyl, propyl, isopropyl, butyl, isobutyl, n-butyl, iso-butyl, sec-butyl, or t-butyl.

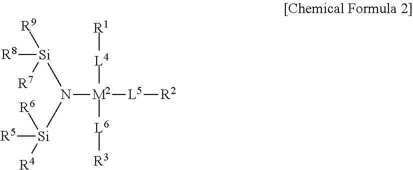

In Chemical Formula, M² denotes Ti, Cr, Mo, W, or Nb;

R¹ to R³ independently denote a substituted or unsubstituted C1 to C10 alkyl group; R⁴ to R⁹ are independently selected from hydrogen, heavy hydrogen, and a substituted or unsubstituted C1 to C10 alkyl group, and L⁴ to L⁶ independently denote —O— or —S—.

The C1 to C10 alkyl group may be a material selected from the group consisting of methyl, ethyl, propyl, isopropyl, n-butyl, isobutyl, sec-butyl, and tert-butyl.

The first precursor and the second precursor may be a material selected independently from a compound represented by Chemical Formula 3, a compound represented by Chemical Formula 4, and a combination thereof.

CpTi(O-iPr)₃ [Chemical Formula 3]

(Me₃Si)₃NTi(O-iPr)₃ [Chemical Formula 4]

here, Cp denotes a substituent represented by Chemical Formula 5, and iPr denotes iso-propyl.

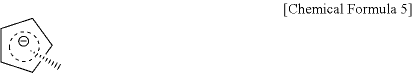

The reactivity gas may be NH₃, H₂, or N₂.

The carbonaceous gas may be selected from C₂H₂, CH₄, C₆H₁₂, C₇H₁₄, or a combination thereof.

The first metal carbide coating layer forming gas and the second metal carbide coating layer forming gas may further include an inert gas for supporting deposition. The inert gas may be He or Ar.

The first metal carbide coating layer and the second metal carbide coating layer may be performed at a temperature range of lower than or equal to 200° C. When the temperature range exceeds 200° C., the base material of the separator may be deformed.

Further, although there is no specific limit in the temperature range, the deposition may be performed at a temperature over the room temperature.

According to another exemplary embodiment in the present disclosure, a method for manufacturing a separator for fuel cell, a first metal carbide coating layer 20 is formed in one or lateral sides of a separator, a metal coating layer 30 is formed above the first metal carbide coating layer 20, and then a graphene or graphite coating layer may be formed.

The method for forming the first metal carbide coating layer and the metal coating layer has already been described, and therefore not further description will be provided.

The graphene or graphite coating layer may formed through a CVD or PECVD process. Since a method for growing graphene or graphite is well known to a person skilled in the art, no further description will be provided.

After forming the graphene or graphite coating layer, a second metal carbide coating layer is formed. In this case, a method for forming the second metal carbide coating layer has already been described, and therefore no further description will be provided.

Hereinafter, examples will be described in detail. However, the following examples are examples of the present disclosure, and therefore the contents of the present disclosure is not limited thereto.

### Example 1

<Manufacturing of First Metal Carbide Coating Layer>

A first precursor containing a compound represented by Chemical Formula CpTi(O-iPr)₃ was evaporated to manufacture a precursor gas.

As a base material, JIS standard SUS316L stainless steel was prepared. The base material was washed with ethanol and acetone to remove a foreign substance in the surface of the base material.

Next, the first precursor gas, NH₃ 100 sccm, C₂H₂ 20 sccm, and Ar 100 sccm were injected into a reaction chamber. In this case, a pressure in the reaction chamber was maintained with about 0.5 Torr. Next, a voltage of 600V was applied to the reaction chamber to change the gases into a plasma state and deposit the plasma-state gases to the base material such that a first TiC coating layer having a thickness of 300 nm was formed.

<Manufacturing of Metal Coating Layer>

After forming a first metal carbide coating layer, a Cu target was prepared and a Cu coating layer was formed with a thickness of 500 nm using a sputtering method.

<Manufacturing of Second Metal Carbide Coating Layer>

A compound represented by Chemical Formula CpTi(O-iPr)₃ was used as a second precursor and a second TiC coating layer having a thickness of 200 nm was formed with the same condition of the forming of the first TiC coating layer.

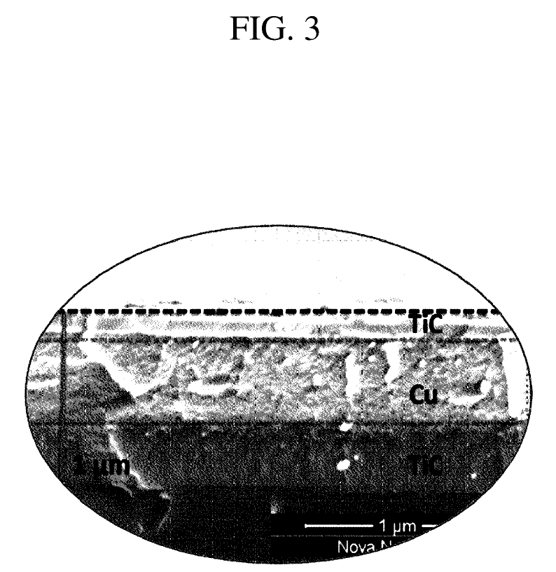

FIG. 3 shows an SEM photo illustrating a cross-section of a coating layer formed by Example 1.

As a result of analysis on a X-ray photoelectron spectroscopy (XPS) depth profile, C in the entire coating layer weight in the first TiC coating layer was 37 atomic % and C in the entire coating layer weight in the second TiC coating layer was 31 atomic %.

### Example 2

Except for using a compound represented by Chemical Formula (Me₃Si)₃NTi(O-iPr)₃ as a first precursor and a second precursor, a separator for fuel cell was manufactured under the same condition of Example 1.

As a result of analysis on a X-ray photoelectron spectroscopy (XPS) depth profile, C in the entire coating layer weight in the first TiC coating layer was 18 atomic % and C in the entire coating layer weight in the second TiC coating layer was 13 atomic %.

### Example 3

A first TiC coating layer and a Cu coating layer were formed with the same condition of Example 1.

Next, a graphene layer was formed with a thickness of 8 nm using a CVD method.

Then, a second TiC coating layer was formed under the same condition of Example 1.

### Example 4

A first TiC coating layer and a Cu coating layer were formed with the same condition of Example 2.

Next, a graphene layer was formed with a thickness of 8 nm using a CVD method.

Then, a second TiC coating layer was formed under the same condition of Example 2.

### Comparative Example 1

As a comparative example 1, a first TiC coating layer was manufactured under the same condition of Example 1.

### Comparative Example 2

As a comparative example 2, a first TiC coating layer was manufactured under the same condition of Example 2.

### Experimental Example 1: Measurement of Sheet Resistance

Sheet resistance was measured using four point probes in the separators for fuel cell, respectively manufactured in Example 1 to Example 4 and Comparative Example 1 to Comparative Example 2.

TABLE 1

| Comparative | 1.6 kΩ | exemplary | 600 Ω | exemplary | 35 Ω |
|---|---|---|---|---|---|
| Example 1 | | embodiment | | embodi- | |
| | | 1 | | ment 3 | |
| Comparative | 214 MΩ | exemplary | 1 MΩ | exemplary | 920 Ω |
| Example 2 | | embodiment | | embodi- | |
| | | 2 | | ment 4 | |

### Experimental Example 2: Measurement of Corrosion Resistance

Corrosion resistance of the separator for fuel cell, manufactured by Example 1 to Example 4 and Comparative Example 1 to Comparative Example 2 was measured through a potentiodynamic polarization test (Pt was used as a counter electrode and a mesh type was used for expansion of surface area.

TABLE 2

| | | | | | |
|---|---|---|---|---|---|
| Comparative | −0.247 V | Example 1 | −0.121 V | Example 3 | 0.081 V |
| Example 1 | | | | | |
| Comparative | −0.148 V | Example 2 | −0.081 V | Example 4 | 0.211 V |
| Example2 | | | | | |

### Experimental Example 3: Measurement of Adhering Force

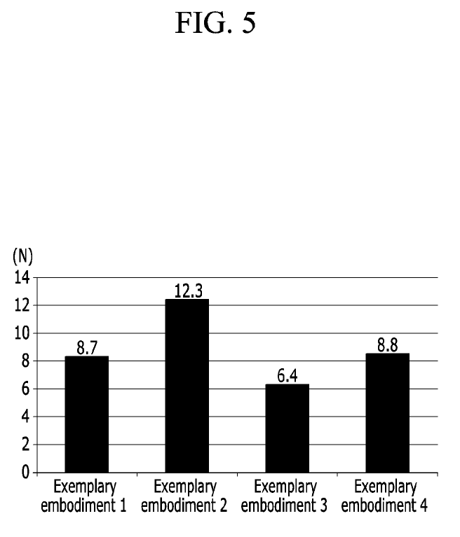

Adhering force of Example 1 to Example 4 was measured using a ISO 20502-standard scratch test method, and a result of the test was shown in the graph of FIG. 5.

Referring to FIG. 3, an adhering force of Example 3 where the graphene coating layer is included was improved by 41.4% compared to that of Example 1, and an adhering force of Example 4 where the graphene coating layer is included was improved by 37.5% compared to that of Example 2.

### Experimental Example 4

A second TiC coating layer was manufactured with different thicknesses as shown in Table 3. Other conditions for forming the second TiC coating layer are the same as those of Example 1.

TABLE 3

| Thickness (nm) | Sheer resistance (Ω) | Corrosion resistance (sce/0.6 V) |
|---|---|---|
| 9 | 42280 | 15.7 |
| 27.3 | 3830 | 16.4 |
| 48.1 | 673 | 10.2 |
| 65.8 | 841 | 5.82 |
| 72.3 | 756 | 3.64 |
| 120.1 | 563 | 2.94 |
| 191.7 | 661 | 2.65 |
| 252.4 | 1022 | 2.45 |
| 371.2 | 1215 | 1.84 |
| 1036.2 | 1613 | 1.12 |

Referring to Table 3, the second metal carbide coating layer has excellent sheer resistance and excellent corrosion resistance when the layer has a thickness of 70 nm to 200 nm.

Although exemplary embodiments in the present disclosure were described above, those skilled in the art would understand that the present disclosure may be implemented in various ways without changing the spirit or necessary features.

Therefore, the embodiments described above are only examples and should not be construed as being limitative in any respects. The scope of the present invention is determined not by the above description, but by the following claims, and all changes or modifications from the spirit, scope, and equivalents of claims should be construed as being included in the scope of the present disclosure.

What is claimed is:

1. A separator for a fuel cell, comprising:
a base layer;
a first metal carbide coating layer disposed at one or both sides of the base layer;
a metal coating layer disposed above the first metal carbide coating layer; and
a second metal carbide coating layer disposed above the metal layer.

2. The separator of claim 1, wherein the first metal carbide coating layer and the second metal carbide coating layer respectively comprise a material selected from titanium carbide, chrome carbide, molybdenum carbide, tungsten carbide, niobium carbide, vanadium carbide, or a combination thereof.

3. The separator of claim 2, wherein the first metal carbide coating layer and the second metal carbide coating layer are both titanium carbide.

4. The separator of claim 2, wherein the metal coating layer comprises a material selected from Cu, Ni, W, Co, Fe, Ru, Ir, Pd, Pt, or a combination thereof.

5. The separator of claim 2, wherein a thickness of the first metal carbide coating layer is about 100 nm to about 1000 nm.

6. The separator of claim 5, wherein a thickness of the metal coating layer is about 100 nm to about 1000 nm.

7. The separator of claim 6, wherein a thickness of the second metal carbide coating layer is about 70 nm to about 200 nm.

8. The separator of claim 1, further comprising a graphene or graphite coating layer provided between the metal coating layer and the second metal carbide coating layer.

9. The separator of claim 8, wherein the thickness of the graphene or graphite coating layer is less than 10 nm.

10. A method for manufacturing a separator for a fuel cell, comprising:
forming a first metal carbide coating layer above a base material;
forming a metal coating layer above the first metal carbide coating layer; and
forming a second metal carbide coating layer above the metal layer.

11. The method of claim 10, wherein the step of forming the first metal carbide coating layer comprises:
producing a first precursor gas by evaporating a first precursor;
introducing a first metal carbide coating layer forming gas containing the precursor gas, a reactive gas, and a carbonaceous gas into a reactive chamber; and
forming a metal nitride coating layer on a base material by changing the first metal carbide coating layer into a plasma state by applying a voltage to the reactive chamber.

12. The method of claim 11, wherein the step of forming the second metal carbide coating layer comprises:
manufacturing a second precursor gas by evaporating a second precursor;
introducing a second metal carbide coating layer forming gas containing the precursor gas, a reactive gas, and a carbonaceous into a reactive chamber; and
forming a metal nitride coating layer on the base material by changing the second metal carbide coating layer forming gas into a plasma state and applying a voltage to the reactive chamber.

13. The method of claim 12, wherein the first precursor and the second precursor are respectively materials selected from a compound represented by Chemical Formula 1, a compound represented by Chemical Formula 2, and a combination thereof: 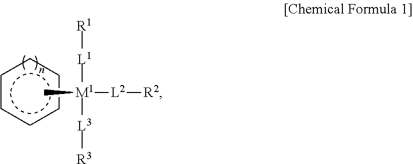
wherein M¹ denotes a material selected from Ti, Cr, Mo, W, or Nb,
R¹ to R³ independently denote a substituted or unsubstituted C1 to C10 alkyl group,
L¹ to L³ are independently —O— or —S—, and n denotes 0 or 1 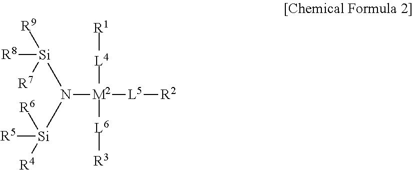
wherein M² denotes Ti, Cr, Mo, W, or Nb;
R¹ to R³ independently denote a substituted or unsubstituted C1 to C10 alkyl group,
R⁴ to R⁹ are independently selected from hydrogen, heavy hydrogen, or a substituted or unsubstituted C1 to C10 alkyl group, and
L⁴ to L⁶ are independently —O— or —S—.

14. The method of claim 13, wherein the first precursor and the second precursor are respectively materials selected from a compound represented by Chemical Formula 3, a compound represented by Chemical Formula 4, and a combination thereof
CpTi(O-iPr)₃ [Chemical Formula 3]
(Me₃Si)₃NTi(O-iPr)₃ [Chemical Formula 4]
wherein Cp denotes a substituent represented, and iPr denotes iso-prophyl

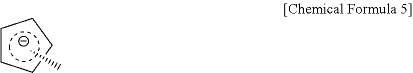

15. The method of claim 14, wherein the reactive gas is NH₃, H₂, or N₂.

16. The method of claim 15, wherein the carbonaceous gas is selected from C₂H₂, CH₄, C₆H₁₂, C₇H₁₄, or a combination thereof.

17. The method of claim 16, wherein the first metal carbide coating layer forming gas and the second metal carbide coating layer forming gas further comprise an inert gas and a hydrogen gas.

18. The method of claim 17, wherein the first metal carbide coating layer and the second metal carbide coating layer are formed at a temperature range of lower than or equal to 200° C.

19. The method of claim 18, wherein the step of forming the metal coating layer is performed by a sputtering method.

20. The method of claim 8, further comprising, after the step of forming the metal coating layer, forming a graphene or graphite coating layer.
